(19) United States
(12) Patent Application Publication
(10) Pub. No.: US 2014/0244932 A1
(43) Pub. Date: Aug. 28, 2014

(54) METHOD AND APPARATUS FOR CACHING AND INDEXING VICTIM PRE-DECODE INFORMATION

(71) Applicant: ADVANCED MICRO DEVICES, INC., Sunnyvale, CA (US)

(72) Inventors: Akarsh D. Hebbar, Austin, TX (US); James D. Dundas, Austin, TX (US); Robert B. Cohen, Austin, TX (US)

(73) Assignee: ADVANCED MICRO DEVICES, INC., Sunnyvale, CA (US)

(21) Appl. No.: 13/779,573

(22) Filed: Feb. 27, 2013

(51) Int. Cl. G06F 12/08

(52) U.S. Cl. CPC G06F 12/0875
USPC 711/122

(57) ABSTRACT

The present invention provides a method and apparatus for caching pre-decode information. Some embodiments of the apparatus include a first pre-decode array configured to store pre-decode information for an instruction cache line that is resident in a first cache in response to the instruction cache line being evicted from one or more second cache(s). Some embodiments of the apparatus also include a second array configured to store a plurality of bits associated with the first cache. Subsets of the bits are configured to store pointers to the pre-decode information associated with the instruction cache line.

### CROSS REFERENCE TO RELATED APPLICATIONS

This application is related to U.S. patent application Ser. No. 13/711,403, filed on Dec. 11, 2012, which is incorporated herein by reference in its entirety.

### BACKGROUND

This application relates generally to processing systems, and, more particularly, to caching pre-decode information in processing systems.

Processing systems typically implement a hierarchical cache complex, e.g., a cache complex that includes an L2 cache and one or more L1 caches. For example, in a processing system that implements multiple processor cores, each processor core may have an associated L1 instruction (L1-I) cache and an L1 data (L1-D) cache. The L1-I and L1-D caches may be associated with a higher level L2 cache. When an instruction is scheduled for processing by the processor core, the processor core first attempts to fetch the instruction for execution from the L1-I cache, which returns the requested instruction if the instruction is resident in a cache line of the L1-I cache. However, if the request misses in the L1-I cache, the request is forwarded to the L2 cache. If the request hits in the L2 cache, the L2 cache returns the requested line to the L1-I cache. Otherwise, the L2 cache may request the line from a higher-level cache or main memory.

Pre-decode bits can be generated for instruction cache lines and provided to a decoder to indicate beginning and end bytes for instructions in the instruction cache line. Using pre-decode bits can help the decoder maintain a higher instruction throughput per cycle and meet target timing requirements. The number of instructions per cycle (IPC) can be maintained by preserving the instruction pre-decode information following an L1 instruction cache miss (e.g., the 64 bits of pre-decode information generated for each 64 byte L1 instruction cache line). Instruction pre-decode information may therefore be saved in the L2 cache following eviction of the corresponding cache line from the L1 instruction cache. For example, 64 bits of pre-decode information may be added to the L2 cache for every 64 byte L2 cache line.

### SUMMARY OF EMBODIMENTS

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

As discussed herein, generating pre-decode bits for instruction cache lines is conventionally used to maintain higher instruction throughputs and meet target timing requirements. However, only a small percentage of cache lines are marked as valid instruction lines at any one time on most workloads. For example, approximately ¼ to ⅛ of lines in an L2 cache typically are marked as instruction lines and reminder of the cache lines are marked as data lines or invalid lines. Consequently, allocating 64 bits to all of the cache lines in the L2 cache for storing pre-decode information unnecessarily consumes chip area and power because only a small fraction of these bits are used to store actual pre-decode information at any particular time.

The disclosed subject matter is directed to addressing the effects of one or more of the problems set forth above.

In some embodiments, an apparatus is provided for caching pre-decode information. Some embodiments of the apparatus include a first pre-decode array configured to store pre-decode information for an instruction cache line that is resident in a first cache in response to the instruction cache line being evicted from one or more second cache(s). Some embodiments of the apparatus also include a second array configured to store a plurality of bits associated with the first cache. Subsets of the bits are configured to store pointers to the pre-decode information associated with the instruction cache line.

In some embodiments, a method is provided for caching pre-decode information. Some embodiments of the method include storing, in a pre-decode array, pre-decode information for an instruction cache line that is resident in a first cache in response to the instruction cache line being evicted from one or more second caches. Some embodiments of the method also include storing a pointer to the pre-decode information in a subset of a plurality of bits associated with the first cache.

In some embodiments, a computer readable media is provided that includes instructions that when executed can configure a manufacturing process used to manufacture a semiconductor device. Some embodiments of the semiconductor device include a first pre-decode array configured to store pre-decode information for an instruction cache line that is resident in a first cache in response to the instruction cache line being evicted from one or more second caches. Some embodiments of the semiconductor device also include a second array configured to store a plurality of bits associated with the first cache. Subsets of the bits are configured to store pointers to the pre-decode information associated with the instruction cache line.

### BRIEF DESCRIPTION OF THE DRAWINGS

The disclosed subject matter may be understood by reference to the following description taken in conjunction with the accompanying drawings, in which like reference numerals identify like elements, and in which:

FIG. 1 conceptually illustrates an example of a computer system, according to some embodiments;

FIG. 2 conceptually illustrates an example of a semiconductor device that may be formed in or on a semiconductor wafer (or die), according to some embodiments;

FIG. 3 conceptually illustrates a portion of a semiconductor device that implements an L2 cache and an associated tag array, according to some embodiments;

FIG. 4 conceptually illustrates an example of a computer system, according to some embodiments;

FIG. 5 shows an example of portions of a tag array such as the tag array shown in FIG. 3 and a pre-decode cache such as the pre-decode cache shown in FIG. 2 or the victim pre-decode cache shown in FIG. 4, according to some embodiments;

FIG. 6 depicts an example of a method for configuring pointers into a victim pre-decode cache associated with instruction cache lines in an L2 cache, according to some embodiments; and

FIG. 7 illustrates an example of a method for decoding instruction cache lines using pre-decode information stored in a victim pre-decode cache associated with an L2 cache, according to some embodiments.

While the disclosed subject matter may be modified and may take alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION

Illustrative embodiments are described below. In the interest of clarity, not all features of an actual implementation are described in this specification. It should be appreciated that in the development of any such actual embodiment, numerous implementation-specific decisions should be made, which may vary from one implementation to another. Moreover, it should be appreciated that such a development effort might be complex and time-consuming, but would nevertheless be a routine undertaking for those of ordinary skill in the art having the benefit of this disclosure. The description and drawings merely illustrate the principles of the claimed subject matter. It should thus be appreciated that those skilled in the art may be able to devise various arrangements that, although not explicitly described or shown herein, embody the principles described herein and may be included within the scope of the claimed subject matter. Furthermore, all examples recited herein are principally intended to be for pedagogical purposes to aid the reader in understanding the principles of the claimed subject matter and the concepts contributed by the inventor(s) to furthering the art, and are to be construed as being without limitation to such specifically recited examples and conditions.

The disclosed subject matter is described with reference to the attached figures. Various structures, systems and devices are schematically depicted in the drawings for purposes of explanation only and so as to not obscure the description with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition is expressly set forth in the specification in a definitional manner that directly and unequivocally provides the special definition for the term or phrase. Additionally, the term, “or,” as used herein, refers to a non-exclusive “or,” unless otherwise indicated (e.g., “or else” or “or in the alternative”). Also, the various embodiments described herein are not necessarily mutually exclusive, as some embodiments can be combined with one or more other embodiments to form new embodiments.

As discussed herein, allocating a set of bits to all of the cache lines in the L2 cache for storing pre-decode information unnecessarily consumes chip area and power. The present application therefore describes embodiments of processing devices that implement a pre-decode array to store pre-decode information for instruction cache lines that have been evicted from another cache such as an L1 instruction cache. For example, a 512 kB L2 cache in a processing device may be associated with an L2 pre-decode cache that includes 64 kB for storing uncompressed pre-decode information for the evicted L1 instruction cache lines. The L2 cache can also store pointers to the portion of the L2 pre-decode cache associated with the evicted instruction cache lines. Some embodiments of the L2 cache may store the pointers using repurposed error correction code (ECC) bits. For example, each line in the L2 cache may be allocated a set of ECC bits. However, all of the allocated ECC bits may not be used for instruction cache lines because instructions can be reloaded from main-memory or an L3 cache on an error detected with a subset of the ECC bits instead of using all of the ECC bits to correct the instruction-only line in situ. The unused ECC bits may therefore be used to store branch target information or a pointer to the L2 pre-decode cache. Some embodiments of the pointers may be compressed to reduce the number of bits used for the pointers.

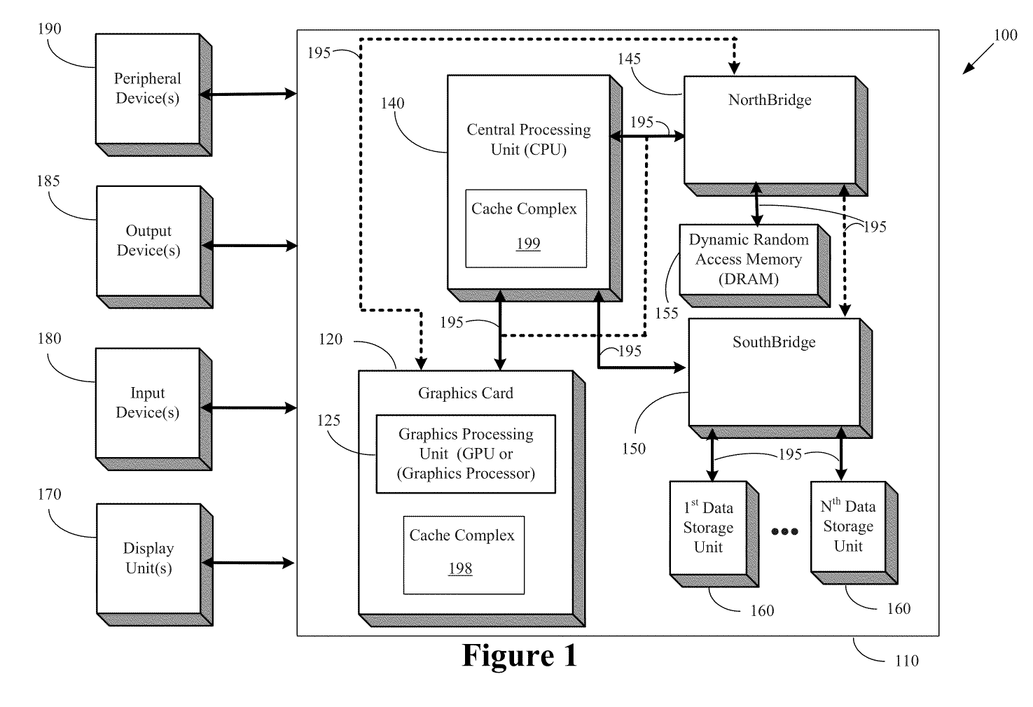

FIG. 1 conceptually illustrates an example of a computer system 100, according to some embodiments. In some embodiments, the computer system 100 may be a personal computer, a smart TV, a laptop computer, a handheld computer, a netbook computer, a mobile device, a tablet computer, a netbook, an ultrabook, a telephone, a personal data assistant (PDA), a server, a mainframe, a work terminal, or the like. The computer system includes a main structure 110 which may include a computer motherboard, system-on-a-chip, circuit board or printed circuit board, a desktop computer enclosure or tower, a laptop computer base, a server enclosure, part of a mobile device, tablet, personal data assistant (PDA), or the like. Some embodiments of the computer system 100 run operating systems such as Linux®, Unix®, Windows®, Mac OS®, or the like.

Some embodiments of the main structure 110 include a graphics card 120. For example, the graphics card 120 may be an ATI Radeon™ graphics card from Advanced Micro Devices (“AMD”). The graphics card 120 may, in some embodiments, be connected on a Peripheral Component Interconnect (PCI) Bus (not shown), PCI-Express Bus (not shown), an Accelerated Graphics Port (AGP) Bus (also not shown), or other electronic or communicative connection. Some embodiments of the graphics card 120 may contain a graphics processing unit (GPU) 125 used in processing graphics data. The graphics card 120 may be referred to as a circuit board or a printed circuit board or a daughter card or the like.

The computer system 100 shown in FIG. 1 also includes a central processing unit (CPU) 140, which is electronically or communicatively coupled to a northbridge 145. The CPU 140 and northbridge 145 may be housed on the motherboard (not shown) or some other structure of the computer system 100. Some embodiments of the graphics card 120 may be coupled to the CPU 140 via the northbridge 145 or some other electromagnetic or communicative connection. For example, CPU 140, northbridge 145, or GPU 125 may be included in a single package or as part of a single die or “chip.” In some embodiments, the northbridge 145 may be coupled to a system RAM 155 (e.g., DRAM) and in some embodiments the system RAM 155 may be coupled directly to the CPU 140. The system RAM 155 may be of any RAM type known in the art; the type of RAM 155 may be a matter of design choice. In some embodiments, the northbridge 145 may be connected to a southbridge 150. The northbridge 145 and southbridge 150 may be on the same chip in the computer system 100 or the northbridge 145 and southbridge 150 may be on different chips. In some embodiments, the southbridge 150 may be connected to one or more data storage units 160. The data storage units 160 may be hard drives, solid state drives, magnetic tape, or any other writable media used for storing data. The CPU 140, northbridge 145, southbridge 150, graphics processing unit 125, or DRAM 155 may be a computer chip or a silicon-based computer chip, or may be part of a computer chip or a silicon-based computer chip. In one or more embodiments, the various components of the computer system 100 may be operatively, electromagnetically, or physically connected or linked with a bus 195 or more than one bus 195.

The computer system 100 may be connected to one or more display units 170, input devices 180, output devices 185, or peripheral devices 190. In some embodiments, these elements may be internal or external to the computer system 100, and may be wired or wirelessly connected. The display units 170 may be internal or external monitors, television screens, handheld device displays, touchscreens, and the like. The input devices 180 may be any one of a keyboard, mouse, track-ball, stylus, mouse pad, mouse button, joystick, touchscreen, scanner or the like. The output devices 185 may be any one of a monitor, printer, plotter, copier, or other output device. The peripheral devices 190 may be any other device that can be coupled to a computer. Example peripheral devices 190 may include a CD/DVD drive capable of reading or writing to physical digital media, a USB device, Zip Drive, external hard drive, phone or broadband modem, router/gateway, access point or the like.

The GPU 120 and the CPU 140 may be associated with cache complexes 198, 199, respectively. In some embodiments, the cache complexes 198, 199 are hierarchical cache complexes that include a hierarchy of caches. For example, the cache complexes 198, 199 may include an inclusive L2 cache (not shown in FIG. 1) that is associated with one or more L1 instruction or data caches (not shown in FIG. 1). The cache complexes 198, 199 may read or write information to or from memory elements such as the DRAM 155 or the data storage units 160. The cache complexes 198, 199 may also receive or respond to probes, sniffs, or snoops from other elements in the system 100 including the northbridge 145, the southbridge 150, or other elements. As discussed herein, the cache complexes 198, 199 can be configured so that higher level caches (such as an L2 cache) are associated with a pre-decode cache that is configured to store pre-decode information for instruction cache lines that have been evicted from lower level caches such as L1 instruction caches. The higher level cache can also access pointers to the portion of the pre-decode cache associated with the evicted instruction cache lines. Some embodiments may store the pointers using repurposed error correction code (ECC) bits.

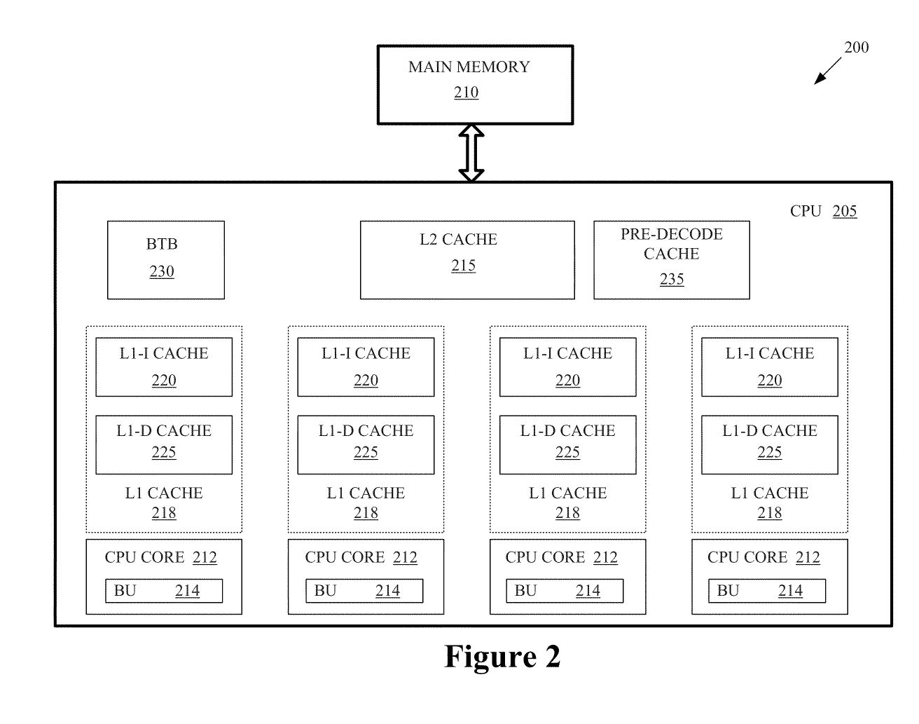

FIG. 2 conceptually illustrates an example of a semiconductor device 200 that may be formed in or on a semiconductor wafer (or die), according to some embodiments. The semiconductor device 200 may be formed in or on the semiconductor wafer using well known processes such as deposition, growth, photolithography, etching, planarizing, polishing, annealing, and the like. Some embodiments of the device 200 include a CPU 205 that is configured to access instructions or data that are stored in the main memory 210. The CPU 205 shown in FIG. 2 includes four processor cores 212 that may be used to execute the instructions or manipulate the data. The processor cores 212 may include a bus unit (BU) 214 for managing communication over bridges or buses in the processing system 200. The CPU 205 shown in FIG. 2 also implements a hierarchical (or multilevel) cache system that is used to speed access to the instructions or data by storing selected instructions or data in the caches. However, persons of ordinary skill in the art having benefit of the present disclosure should appreciate that some embodiments of the device 200 may implement different configurations of the CPU 205, such as configurations that use external caches, different types of processors (e.g., GPUs or APUs), or different numbers of processor cores 212. Moreover, some embodiments may associate different numbers or types of caches 218, 220, 225 with the different processor cores 212.

The cache system depicted in FIG. 2 includes a level 2 (L2) cache 215 for storing copies of instructions or data that are stored in the main memory 210. The L2 cache 215 shown in FIG. 2 is 4-way associative to the main memory 210 so that each line in the main memory 210 can potentially be copied to and from four cache lines (which are conventionally referred to as “ways”) in the L2 cache 215. However, persons of ordinary skill in the art having benefit of the present disclosure should appreciate that embodiments of the main memory 210 or the L2 cache 215 can be implemented using any associativity including 2-way associativity, 8-way associativity, 16-way associativity, direct mapping, fully associative caches, and the like. Relative to the main memory 210, the L2 cache 215 may be implemented using faster memory elements. The L2 cache 215 may also be deployed logically or physically closer to the processor core 212 (relative to the main memory 210) so that information may be exchanged between the CPU core 212 and the L2 cache 215 more rapidly or with less latency.

The illustrated cache system also includes L1 caches 218 for storing copies of instructions or data that are stored in the main memory 210 or the L2 cache 215. Each L1 cache 218 is associated with a corresponding processor core 212. The L1 cache 218 may be implemented in the corresponding processor core 212 or the L1 cache 218 may be implemented outside the corresponding processor core 212 and may be physically, electromagnetically, or communicatively coupled to the corresponding processor core 212. Relative to the L2 cache 215, the L1 cache 218 may be implemented using faster memory elements so that information stored in the lines of the L1 cache 218 can be retrieved quickly by the corresponding processor core 212. The L1 cache 218 may also be deployed logically or physically closer to the processor core 212 (relative to the main memory 210 and the L2 cache 215) so that information may be exchanged between the processor core 212 and the L1 cache 218 more rapidly or with less latency (relative to communication with the main memory 210 and the L2 cache 215).

Some embodiments of the L1 caches 218 are separated into level 1 (L1) caches for storing instructions and data, which are referred to as the L1-I cache 220 and the L1-D cache 225. Separating or partitioning the L1 cache 218 into an L1-I cache 220 for storing instructions and an L1-D cache 225 for storing data may allow these caches to be deployed closer to the entities that are likely to request instructions or data, respectively. Consequently, this arrangement may reduce contention, wire delays, and generally decrease latency associated with instructions and data. A replacement policy dictates that the lines in the L1-I cache 220 are replaced with instructions from the L2 cache 215 and the lines in the L1-D cache 225 are replaced with data from the L2 cache 215. However, persons of ordinary skill in the art should appreciate that some embodiments of the L1 caches 218 may be partitioned into different numbers or types of caches that operate according to different replacement policies. Furthermore, persons of ordinary skill in the art should appreciate that some programming or configuration techniques may allow the L1-I cache 220 to store data or the L1-D cache 225 to store instructions, at least on a temporary basis.

The L2 cache 215 illustrated in FIG. 2 is inclusive so that cache lines resident in the L1 caches 218, 220, 225 are also resident in the L2 cache 215. Persons of ordinary skill in the art having benefit of the present disclosure should appreciate that the L1 caches 218 and the L2 cache 215 represent one example embodiment of a multi-level hierarchical cache memory system. However, some embodiments may use different multilevel caches including elements such as L0 caches, L1 caches, L2 caches, L3 caches, and the like, some of which may or may not be inclusive of the others.

In operation, because of the low latency, a core 212 first checks its corresponding L1 caches 218, 220, 225 when it needs to retrieve or access an instruction or data. If the request to the L1 caches 218, 220, 225 misses, then the request may be directed to the L2 cache 215, which can be formed of a relatively slower memory element than the L1 caches 218, 220, 225. The main memory 210 is formed of memory elements that are slower than the L2 cache 215. For example, the main memory may be composed of denser (smaller) DRAM memory elements that take longer to read and write than the SRAM cells typically used to implement caches. The main memory 210 may be the object of a request in response to cache misses from both the L1 caches 218, 220, 225 and the inclusive L2 cache 215. The L2 cache 215 may also receive external probes, e.g. via a bridge or a bus, for lines that may be resident in one or more of the corresponding L1 caches 218, 220, 225.

Some embodiments of the CPU 205 include a branch target buffer (BTB) 230 that is used to store branch information associated with cache lines in the L1 caches 218, 220, 225. The BTB 230 shown in FIG. 2 is a separate cache of branch instruction information including target address information for branch instructions that may be included in the cache lines in the L1 caches 218, 220, 225. The BTB 230 uses its own tags to identify the branch instruction information associated with different cache lines. Although the BTB 230 is depicted in FIG. 2 as a single entity separate from the L1 caches 218, 220, 225, persons of ordinary skill in the art having benefit of the present disclosure should appreciate that some embodiments of the CPU 205 may include multiple instances of the BTB 230 that are implemented in or associated with the different L1 caches 218, 220, 225.

Some embodiments of the BTB 230 implement a sparse/dense branch marker arrangement in which sparse entries are logically tied to the L1-I cache 220 and are evicted to a silo in the L2 cache 215 on an L1 cache line eviction. For example, the BTB 230 may store information associated with the first N branches in program order in a cache line in a structure (which may be referred to as the “sparse”) that is logically tied to each line in the L1 instruction cache and uses the same tags as the L1 instruction cache. Some embodiments may augment the information in the sparse by adding a small (“dense”) BTB that caches information about branches in L1 cache lines that contain more than N branches. Examples of sparse and dense prediction caches may be found in U.S. Pat. No. 8,181,005 (“Hybrid Branch Prediction Device with Sparse and Dense Prediction Caches,” Gerald D. Zuraski, et al), which is incorporated by reference herein in its entirety. Examples of branch target information include, but are not limited to, information indicating whether the branch is valid, an end address of the branch, a bias direction of the branch, an offset, whether the branch target is in-page, or whether the branch is conditional, unconditional, direct, static, or dynamic. As discussed herein, branch target information in the BTB 230 may be provided to the L2 cache 215 when the associated line is evicted from one of the L1 caches 218, 220, 225.

Some embodiments of the CPU 205 include logic for storing branch instruction information for branches in cache lines of an inclusive L2 cache. The branch instruction information may be stored in the L2 cache (or in an associated structure) in response to the cache line being evicted from the associated L1-I cache. In some embodiments, the branch instruction information may be provided to the L2 cache by evicting the sparse branch information corresponding to branches in L1-I cache lines that have been evicted from the L1 instruction cache out to the L2 cache. The branch information can then be stored (or “siloed”) in additional bits that are associated with each L2 cache line. Some embodiments may store the information in L2 cache line ECC bits that are not needed to detect errors in L2 cache lines that only contain instructions. For example, if a requested cache line holds instructions, unused error correction code (ECC) bits in a data array in the inclusive L2 cache can be used to store (or “silo”) the branch instruction markers for two branches associated with the cache line.

A portion of the ECC bits associated with instruction lines in the L2 cache 215 may also be used to store pointers into a pre-decode cache 235 that is used to store pre-decode information associated with cache lines that are evicted from the L1-I caches 220. For example, the pre-decode cache 235 may be implemented as an 8-16 kB array for storing pre-decode information for the evicted instruction cache lines. The pointers stored in the repurposed ECC bits may then be used to identify the cached pre-decode information, e.g., so that this information can be provided to an L1 pre-decode array or a decoder when an instruction in the associated instruction cache line is fetched into the L1-I cache 220 or provided to a decoder (not shown in FIG. 2). The CPU 205 may therefore compress the branch target information or generate a smaller amount of branch target information so that a portion of the ECC bits is available for storing the pointers.

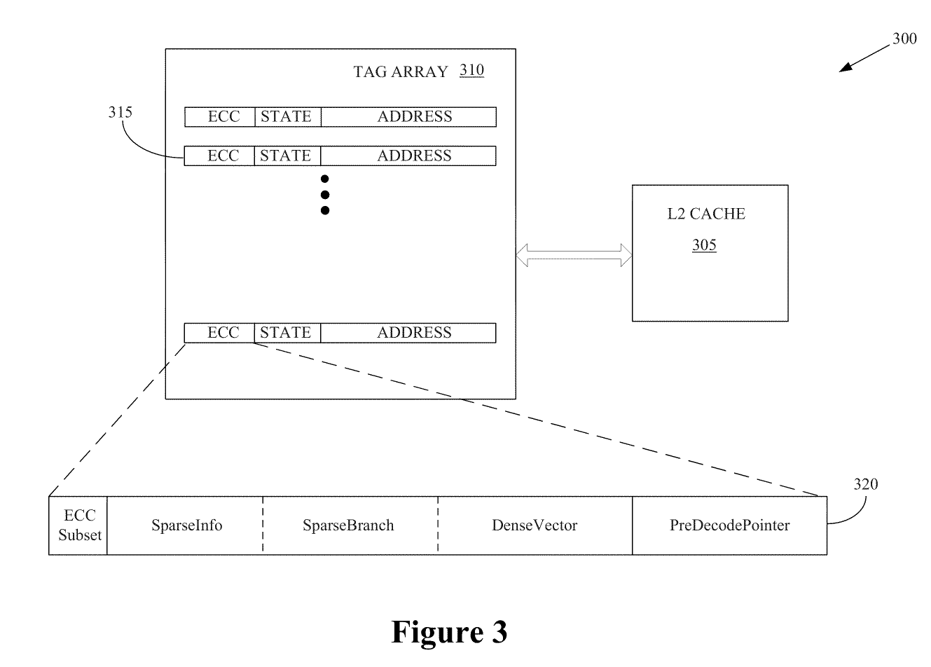

FIG. 3 conceptually illustrates a portion 300 of a semiconductor device that implements an L2 cache 305 and an associated tag array 310, according to some embodiments. Some embodiments of the portion 300 may be implemented in semiconductor devices such as the semiconductor device 100 depicted in FIG. 1 or the semiconductor device 200 shown in FIG. 2. The tag array 310 includes one or more lines 315 (only one indicated by a reference numeral in FIG. 3) that indicate the connection between lines of the cache 305 and the lines in the main memory (or other cache memory) that include a version of the data stored in the corresponding line of the cache 305. Each line 315 depicted in FIG. 3 includes the address of the location in the associated memory that includes a version of the data, one or more state bits that are used to indicate the state of the data in the corresponding line of the cache (e.g., whether the cached information is valid), and one or more error correcting code (ECC) bits that can be used to store information used to detect or correct errors in either the state bits or the address bits. Some embodiments may alternatively store some or all of the ECC bits in another location such as a data array.

As discussed herein, the full complement of ECC bits may not be used to store error correction information for instruction cache lines because instructions can be reloaded from main-memory or other caches in response to detecting an error on the basis of a subset of the ECC bits. Consequently, a subset of the ECC bits may be used to store the error detection information and the remainder of the bits may remain available for other purposes. Some embodiments of the tag array 310 may store branch information associated with the corresponding cache line in the ECC bits that are not needed to detect errors in L2 lines that only contain instructions. For example, if a requested cache line holds instructions, the ECC data array 320 may be used to store a subset of the ECC bits and the unused error correction code (ECC) bits in the ECC data array 320 can be used to store (or “silo”) the branch instruction information (SparseInfo, SparseBranch, and DenseVector) for one or more branches associated with the cache line. The branch instruction information may be provided to the tag array 310 by an L1 cache in response to the corresponding line being evicted from the L1 cache.

The ECC data array 320 may also be used to store a pointer into a pre-decode cache such as the pre-decode cache 235 shown in FIG. 2. The branch instruction information may therefore be compressed so that bits may be allocated to the pointers. For example, the ECC data array 320 may include 34 unused ECC bits for instruction cache lines, e.g., because only parity information is stored for the instruction cache lines. The branch target information may therefore be compressed to less than 34 b, either using logic to compress the 34 b of information generated elsewhere in the semiconductor device or by generating less than 34 b of branch target information. For example, the branch target information can be reduced to 25 b so that nine bits are available to store the pointer to the pre-decode information associated with the instruction cache line. However, persons of ordinary skill in the art having benefit of the present disclosure should appreciate that the particular partitioning of the bits of the ECC data array 320 into ECC or parity information, branch target information, or pointer bits is a matter of design choice.

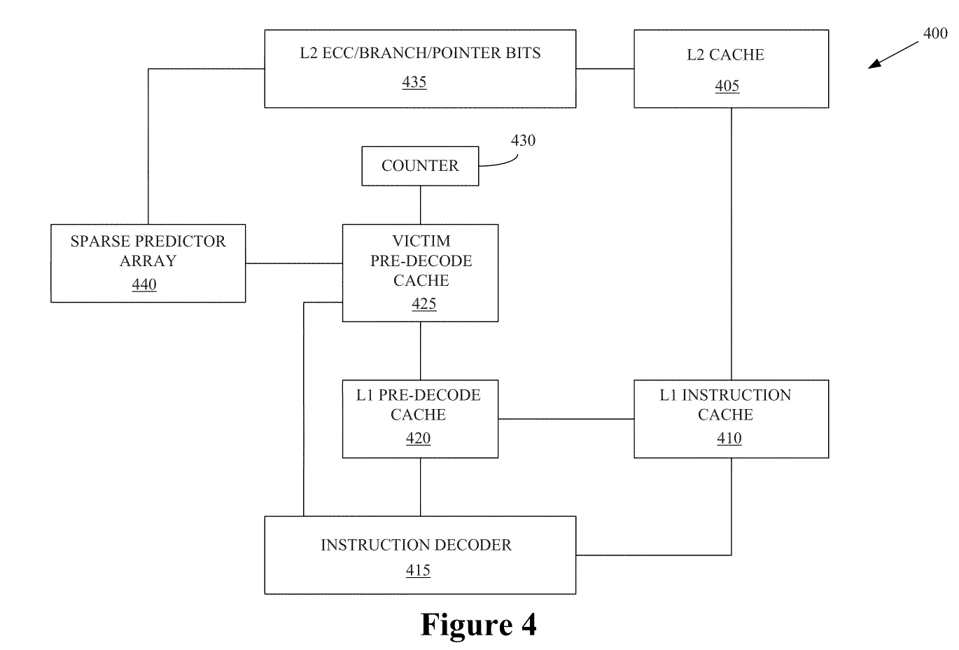

FIG. 4 conceptually illustrates an example of a computer system 400, according to some embodiments. The computer system 400 shown in FIG. 4 includes an L2 cache 405 (such as the L2 cache 215 shown in FIG. 2 or the L2 cache 300 shown in FIG. 3) and one or more L1 instruction caches 410 (such as the L1-I caches 220 shown in FIG. 2). The L1 instruction cache 410 stores instructions in instruction cache lines so that the instructions may be provided to an instruction decoder 415 for decoding and eventual execution by the computer system 400. The L1 instruction cache 410 is communicatively coupled to an L1 pre-decode cache 420 that is configured to store pre-decode information associated with the cache lines in the L1 instruction cache 410. The pre-decode information stored in the L1 pre-decode cache 420 may also be provided to the instruction decoder 415 to facilitate decoding of instructions in the instruction cache lines provided by the L1 instruction cache 410.

If a request for an instruction misses in the L1 instruction cache 410, the requested instruction cache line may be fetched from the L2 cache 405 and an instruction cache line may be evicted from the L1 instruction cache 410 to the L2 cache 405 in accordance with a replacement policy to make room for the fetched instruction cache line. Pre-decode information for the evicted cache line may also be evicted from the L1 pre-decode cache 420 to a victim (or L2) pre-decode cache 425 when the corresponding instruction cache line is evicted from the L1 instruction cache 410. An incremental counter 430 may be used to associate a counter value with the evicted pre-decode information when this information is stored in the victim pre-decode cache 425. Values of bits in a bit array 435 associated with the L2 cache 405 may be set or modified to encode ECC information, branch predictor information, or a pointer to the pre-decode information in the victim pre-decode cache 425 in response to the cache line being evicted, as discussed herein.

The cached information may then be used to reload the L1 instruction cache 410 and the L1 pre-decode cache 420, e.g., in response to a request for an instruction in the corresponding instruction cache line in the L2 cache 405. For example, the L1 instruction cache 410 may request an instruction cache line from the L2 cache 405, which may provide the requested instruction cache line. The request may also be used to access the ECC/branch/pointer bits 435 that are associated with the requested instruction cache line. The branch information bits from the ECC/branch/pointer bits 435 may be provided to a sparse predictor array 440 that uses the branch prediction information in the bits to access the sparse or dense branch arrays such as the BTB 230 shown in FIG. 2. The sparse predictor array 440 may also use the pointer bits to access the pre-decode information corresponding to the requested instruction cache line in the victim pre-decode cache 425. The accessed pre-decode information may then be provided to the L1 pre-decode cache 420 potentially for subsequent forwarding to the instruction decoder 415. Some embodiments of the victim pre-decode cache 425 may be able to bypass the L1 pre-decode cache 420 and provide the access pre-decode information directly to the instruction decoder 415.

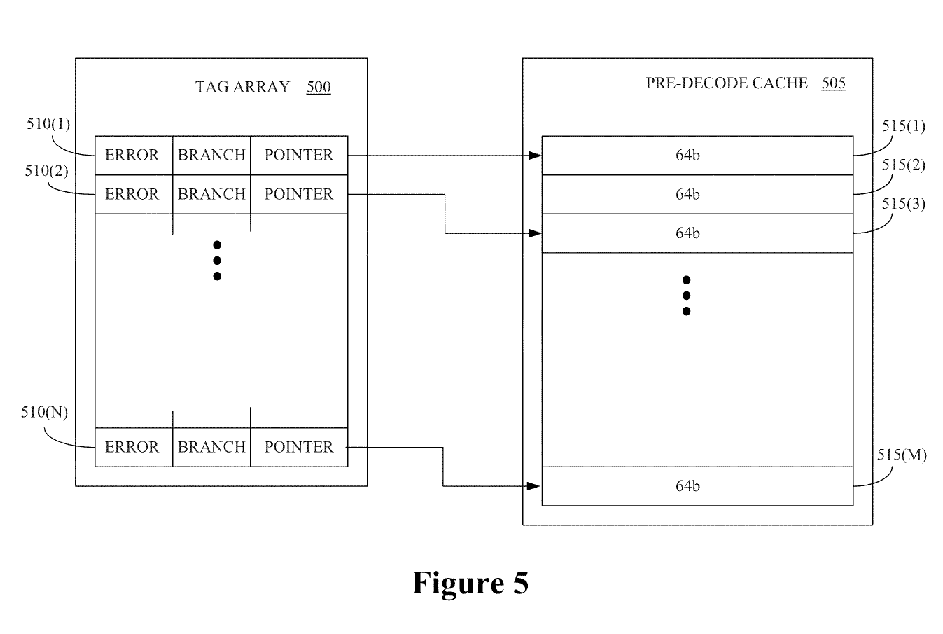

FIG. 5 shows an example of portions of a tag array 500 such as the tag array 310 shown in FIG. 3 and a pre-decode cache 505 such as the pre-decode cache 235 shown in FIG. 2 or the victim pre-decode cache 425 shown in FIG. 4, according to some embodiments. The tag array 500 shown in FIG. 5 includes sets of bits in a tag array entry 510 that can be used to store error detection or correction information (ERROR), branch prediction information (BRANCH), or a pointer to pre-decode information 515 in the pre-decode cache 505 (POINTER), as discussed herein. For example, the ERROR field of the tag array entry 510 may be configured to store parity bits, the BRANCH field of the tag array entry 510 may be configured to store branch prediction information, and the POINTER field of the tag array entry 510 may be used to store a pointer for up to N instruction cache lines in a corresponding L2 cache such as the L2 cache 405 shown in FIG. 4. For another example, the ERROR field of the tag array entry 510 may store information that can be used to reconstruct lost branch marker bits. Some embodiments of the tag array 500 may also be configured to store ECC information associated with data cache lines in the corresponding L2 cache, as discussed herein.

The pointers in each set of bits 510 may be used to point to corresponding lines of pre-decode information 520 in the pre-decode cache 505. For example, the bits 510(1) may store values of bits that represent a pointer to the line 515(1), the bits 510(2) may store values of bits that represent a pointer to the line 515(3), and the bits 510(M) may store values of bits that represent a pointer to the line 515(M). The lines 515 in the pre-decode cache 505 shown in FIG. 5 include 64-bits for storing pre-decode information for 64 B instruction cache lines. The overall size of the pre-decode cache 505 may be approximately 8-16 kB. However, persons of ordinary skill in the art having benefit of the present disclosure should appreciate that the length of instruction cache lines, the number of bits used to store pre-decode information, or the size of the pre-decode cache 505 are matters of design choice.

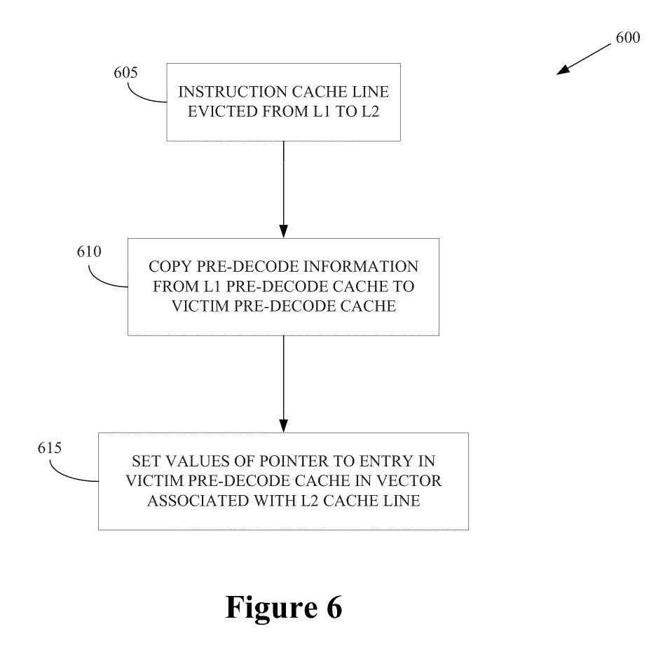

FIG. 6 depicts an example of a method 600 for configuring pointers into a victim pre-decode cache associated with instruction cache lines in an L2 cache, according to some embodiments. Some embodiments of the method 600 may be implemented in the CPU 205 using the L2 cache 215, the L1 instruction cache 220, and the pre-decode cache 235 shown in FIG. 2. The method 600 begins in response to an instruction cache line being evicted (at 605) from an L1 instruction cache. Pre-decode information may then be copied (at 605) from an L1 pre-decode cache associated with the L1 instruction cache to the victim pre-decode cache associated with the L2 cache. Some embodiments of the method 600 may include erasing or invalidating the pre-decode information in the L1 pre-decode cache in response to copying (at 605) this information to the victim pre-decode cache. Values of bits representing a pointer to an entry in the victim pre-decode cache that includes the evicted pre-decode information may then be set (at 610). For example, values of bits in a vector associated with the L2 cache line that includes the evicted instruction cache line may be set (at 610) to represent a pointer to the corresponding entry in the victim pre-decode cache.

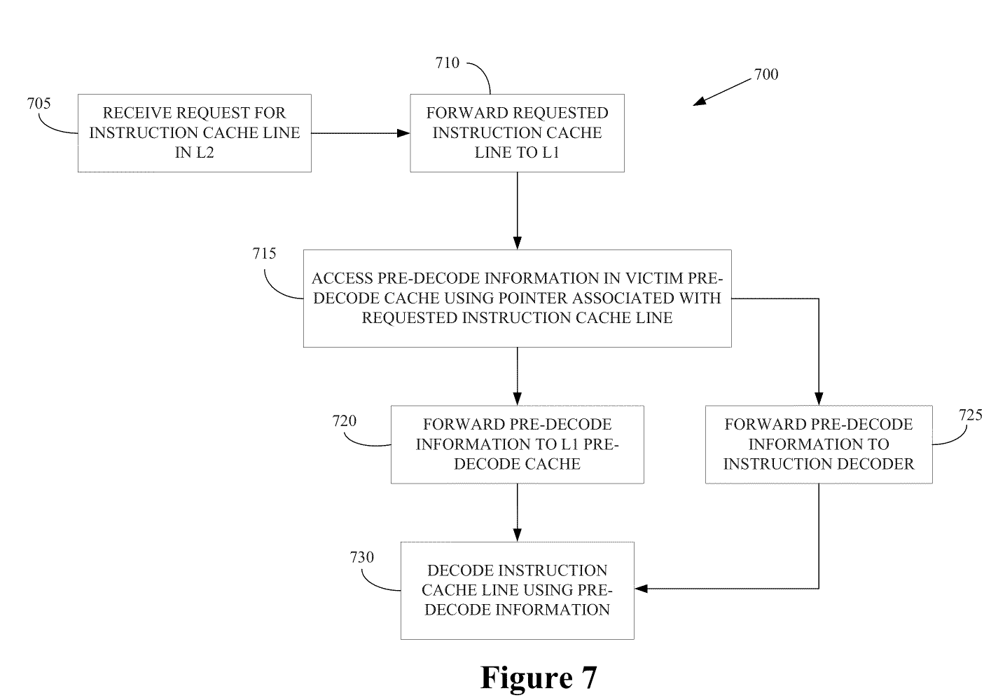

FIG. 7 illustrates an example of a method 700 for decoding instruction cache lines using pre-decode information stored in a victim pre-decode cache associated with an L2 cache, according to some embodiments. Some embodiments of the method 700 may be implemented using the L2 cache 405, the L1 instruction cache 410, the instruction decoder 415, and the victim pre-decode cache 425 depicted in FIG. 4. The method 700 begins in response to the L2 cache receiving (at 705) a request for an instruction cache line. The L2 cache may then forward (at 710) the requested instruction cache line to the L1 instruction cache, which may subsequently provide the requested instruction cache line to the instruction decoder for decoding.

Pre-decode information may be accessed (at 715) using pointer information associated with the L2 instruction cache line. For example, the pointer information may be used to access (at 715) the pre-decode information from a victim pre-decode cache (such as the victim pre-decode cache 425 shown in FIG. 4), as discussed herein. For another example, a sparse predictor array (such as the sparse predictor array 440 shown in FIG. 4) may use the pointer information to access (at 715) the pre-decode information from a sparse or dense array in a BTB such as the BTB 230 shown in FIG. 2, as discussed herein. The pre-decode information may then be forwarded (at 720) to the L1 pre-decode cache, which may subsequently forward this information to the instruction decoder. Some embodiments of the method 700 may be able to bypass the L1 pre-decode cache and forward (at 725) the pre-decode information directly to the instruction decoder. Although the steps 710, 715, and 720/725 are depicted sequentially in FIG. 7, persons of ordinary skill in the art having benefit of the present disclosure should appreciate that some embodiments of the method 700 may perform the steps in a different order, simultaneously, or concurrently. Once the instruction decoder has received the instruction cache line and the corresponding pre-decode information, the instruction decoder may decode (at 730) the instruction cache line using the corresponding pre-decode information.

Some of the embodiments described herein may have a number of advantages over the conventional practice of allocating pre-decode bits to every cache line in an L2 cache. For example, 64 bits of pre-decode information is used for each 64 B L2 cache line. Allocating one bit of pre-decode information per byte of information stored in each cache line of the L2 cache implies that approximately one eighth of a conventional L2 cache would be consumed by the pre-decode information bits. For example, a conventional 2 MB L2 cache (such as may be used in a processing system that includes four processing cores with 32 kB L1 instruction caches) would need to allocate approximately 256 kB for storing pre-decode information. However, as discussed herein, although every cache line in an L2 cache could potentially hold an instruction cache line, most cache lines in an L2 cache typically include data and only a relatively small fraction of the lines in an L2 cache include instruction cache lines at any particular time. Thus, a comparatively small pre-decode cache can be used to store the pre-decode information for the instruction cache lines that are resident in the L2 cache. For example, victim pre-decode caches of approximately 4 kB/core can be used to store the pre-decode cache for a 2 MB L2 cache. Some embodiments may therefore save approximately 256 KB pre-decode array for a 2 MB L2 cache, which represents a reduction of approximately 12% in the overall size of L2 cache. Simulations have demonstrated that the reduction in the size of the L2 cache, and the corresponding die area and power savings, can be achieved with minimal or no reduction in the performance of the L2 cache relative to the conventional architecture that allocates pre-decode bits to each cache line in the L2 cache. Some embodiments may also reduce the amount of time spent by the instruction decoder in forced dynamic decode mode, thereby improving the throughput of the instruction decoder.

Embodiments of processor systems that can cache pre-decode information as described herein (such as the processor system 100) can be fabricated in semiconductor fabrication facilities according to various processor designs. In one embodiment, a processor design can be represented as code stored on a computer readable media. Exemplary codes that may be used to define and/or represent the processor design may include HDL, Verilog, and the like. The code may be written by engineers, synthesized by other processing devices, and used to generate an intermediate representation of the processor design, e.g., netlists, GDSII data and the like. The intermediate representation can be stored on computer readable media and used to configure and control a manufacturing/fabrication process that is performed in a semiconductor fabrication facility. The semiconductor fabrication facility may include processing tools for performing deposition, photolithography, etching, polishing/planarizing, metrology, and other processes that are used to form transistors and other circuitry on semiconductor substrates. The processing tools can be configured and are operated using the intermediate representation, e.g., through the use of mask works generated from GDSII data.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

Furthermore, the methods disclosed herein may be governed by instructions that are stored in a non-transitory computer readable storage medium and that are executed by at least one processor of a computer system. Each of the operations of the methods may correspond to instructions stored in a non-transitory computer memory or computer readable storage medium. In various embodiments, the non-transitory computer readable storage medium includes a magnetic or optical disk storage device, solid state storage devices such as Flash memory, or other non-volatile memory device or devices. The computer readable instructions stored on the non-transitory computer readable storage medium may be in source code, assembly language code, object code, or other instruction format that is interpreted and/or executable by one or more processors.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. An apparatus, comprising:
a first pre-decode array configured to store pre-decode information for an instruction cache line that is resident in a first cache in response to the instruction cache line being evicted from at least one second cache; and
a second array configured to store a plurality of bits associated with the first cache, wherein subsets of the plurality of bits are configured to store pointers to the pre-decode information associated with the instruction cache line.

2. The apparatus of claim 1, wherein the first cache is configured to store one selected from the group consisting of data cache lines or instruction cache lines, and wherein said at least one second cache is configured to store only instruction cache lines.

3. The apparatus of claim 2, wherein the plurality of bits stores error correction code information associated with data cache lines in the first cache, parity information, branch target information, and a pointer to the pre-decode information associated with the instruction cache line in the first cache.

4. The apparatus of claim 3, comprising compression logic for compressing the branch target information based upon a number of bits in the pointer.

5. The apparatus of claim 3, wherein the first cache is an L2 cache and said at least one second cache comprises at least one L1 instruction cache.

6. The apparatus of claim 1, comprising at least one second pre-decode array associated with said at least one second cache, and wherein pre-decode information is evicted from said at least one second pre-decode array to the first pre-decode array in response to the instruction cache line being evicted from said at least one second cache.

7. The apparatus of claim 1, wherein the first cache is configured to store 512 kB for each of said at least one second caches, each of said at least one second caches is configured to store 32 kB, and the first pre-decode array is configured to store 4 kB for each of said at least one second caches.

8. A method, comprising:
storing, in a pre-decode array, pre-decode information for an instruction cache line that is resident in a first cache in response to the instruction cache line being evicted from at least one second cache; and
storing a pointer to the pre-decode information in a subset of a plurality of bits associated with the first cache.

9. The method of claim 8, wherein the first cache is configured to store one selected from the group consisting of data cache lines or instruction cache lines, and wherein said at least one second cache is configured to store only instruction cache lines.

10. The method of claim 9, comprising storing error correction code information associated with a data cache line in the first cache in response to the data cache line being evicted from at least one third cache.

11. The method of claim 9, wherein storing the pointer in the subset of the plurality of bits comprises storing parity information, branch target information, and the pointer in the plurality of bits in response to the instruction cache line being evicted from said at least one second cache.

12. The method of claim 11, comprising compressing the branch target information based upon a number of bits in the pointer prior to storing the parity information, the branch target information, and the pointer in the plurality of bits.

13. The method of claim 8, comprising evicting pre-decode information from at least one second pre-decode array associated with said at least one second cache to the first pre-decode array in response to the instruction cache line being evicted from said at least one second cache.

14. A computer readable media including instructions that when executed can configure a manufacturing process used to manufacture a semiconductor device comprising:
a first pre-decode array configured to store pre-decode information for an instruction cache line that is resident in a first cache in response to the instruction cache line being evicted from at least one second cache; and
a second array configured to store a plurality of bits associated with the first cache, wherein subsets of the plurality of bits are configured to store pointers to the pre-decode information associated with the instruction cache line.

15. The computer readable media set forth in claim 14, wherein the semiconductor device further comprises at least one second pre-decode array associated with said at least one second cache, and wherein pre-decode information is evicted from said at least one second pre-decode array to the first pre-decode array in response to the instruction cache line being evicted from said at least one second cache.
